(19) United States
(12) Patent Application Publication
(10) Pub. No.: US 2005/0034119 A1
(43) Pub. Date: Feb. 10, 2005

(54) Rental program management system

(75) Inventors: Ichiro Koyama, Kawasaki (JP); Wataru Igarashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/943,965

(22) Filed: Sep. 20, 2004

Related U.S. Application Data
(63) Continuation of application No. PCT/JP02/02771, filed on Mar. 22, 2002.

(51) Int. Cl. G06F 9/445

(52) U.S. Cl. 717/174

(57) ABSTRACT

In response to a distribution request from the terminal device 2 of the user, the distribution center 1 downloads and activates an install program in the terminal device 2 of the user. When the installation is completed, the install program issues a completion notification to the distribution center 1, and rental information is recorded in a rental database 12. When the contents are returned, an uninstallation program is downloaded and activated in the terminal device 2 of the user. When the uninstallation is completed, the uninstallation program issues a completion notification to the distribution center 1, and the rental information about the return is recorded in the rental database 12.

### CROSS REFERENCE OF RELATED APPLICATION

This application is a continuation of international PCT application No. PCT/JP02/02771 which was filed on Mar. 22, 2002.

### BACKGROUND OF THE INVENTION

1. Field of the Invention

The present invention relates to a technology for distributing contents such as software, etc. over a network, and more specifically to a technology required when contents for rent are distributed.

2. Description of the Related Art

Recently, with an increasing speed of network communications such as the Internet, a service of distributing contents of a large capacity has been practically realized.

When contents for rent are distributed in the above-mentioned service, the method for charging a rent, the method of uninstalling expired contents, etc. are the problems to be solved.

The present invention aims at realizing the distribution of contents for rent, and providing a technology required when contents for rent are distributed.

### SUMMARY OF THE INVENTION

The rental program management system according to the present invention is based on the use with an information processing system for distributing contents over a communications network to a terminal device of a user, and the server device of the system includes: an installing unit, an uninstalling unit, and a rental information management unit.

The installing unit installs the requested contents for rent on the terminal device in response to a rental request from the terminal device.

The uninstalling unit uninstalls the contents from the terminal device in response to a request from the terminal device to return the contents for rent from the terminal device.

The rental information management unit determines the rental period in which the contents are rented according to the installation completion notification and the uninstallation completion notification from the terminal device.

The server device can further include a charging unit for determining the rent based on the rental period, and sets a special value as the rent when the rent determined based on the rental period exceeds the special value.

The installing unit checks whether or not, in response to the rental request from the terminal device, the requested contents for rent are in an environment in which they can be installed on the terminal device. If they can be installed, the above-mentioned installing process is performed. If they cannot be installed, the installing unit prompts the user of the terminal device to install a necessary program.

According to the present invention, contents can be rented over a network.

### BRIEF DESCRIPTION OF DRAWINGS

FIG. 1 shows the configuration of the system according to an embodiment of the present invention;

FIG. 2 shows an example of the data configuration of each database provided for a distribution center;

FIG. 3 is a sequential view showing the outline of the data communications between the distribution center and the terminal device of a user in a rental process according to an embodiment of the present invention;

FIG. 4 is a sequential view showing the outline of the data communications between the distribution center and the terminal device of a user in the process of returning rented software according to an embodiment of the present invention;

FIG. 5 is a flowchart showing the process performed by the terminal device of a user at the time of member registration, and the process performed by the distribution center when software is rented to a member;

FIG. 6 shows an example of a display screen displayed on the screen of the terminal device of a user when the user selects software;

FIG. 7 shows an example of a display screen displayed on the terminal device of a user when it is determined that the terminal device of the user satisfies the environment in which software can be installed;

FIG. 8 shows an example of a display screen displayed on the terminal device of a user when it is determined that the terminal device of the user does not satisfy the environment in which software can be installed;

FIG. 9 is a flowchart showing the process performed by the terminal device of a user in the process of returning software;

FIG. 10 shows an example of a display screen displayed on the terminal device of a user based on a result of an uninstalling process;

FIG. 11 is a flowchart of the process performed by the distribution center in the returning process;

FIG. 12 is a flowchart of a monthly process performed by the distribution center at specific intervals;

FIG. 13 shows an environment of the system of the server device configuring the distribution center and the system of the terminal device of a user; and

FIG. 14 shows an example of a storage medium.

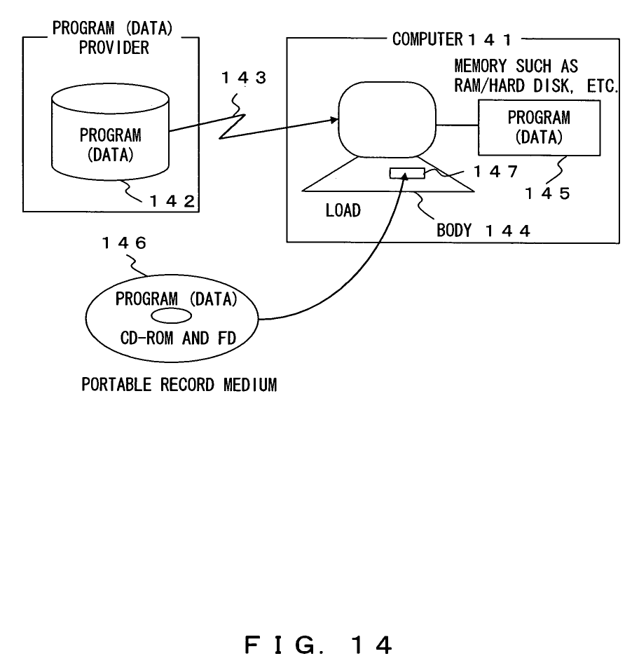

### DESCRIPTION OF THE PREFERRED EMBODIMENTS

An embodiment of the present invention is explained below by referring to the attached drawings.

The following embodiment is an example of the case in which software such as application software, an operating system, etc. is contents to be distributed to a user. The software is based on the configuration designed such that data can be copied but cannot be installed.

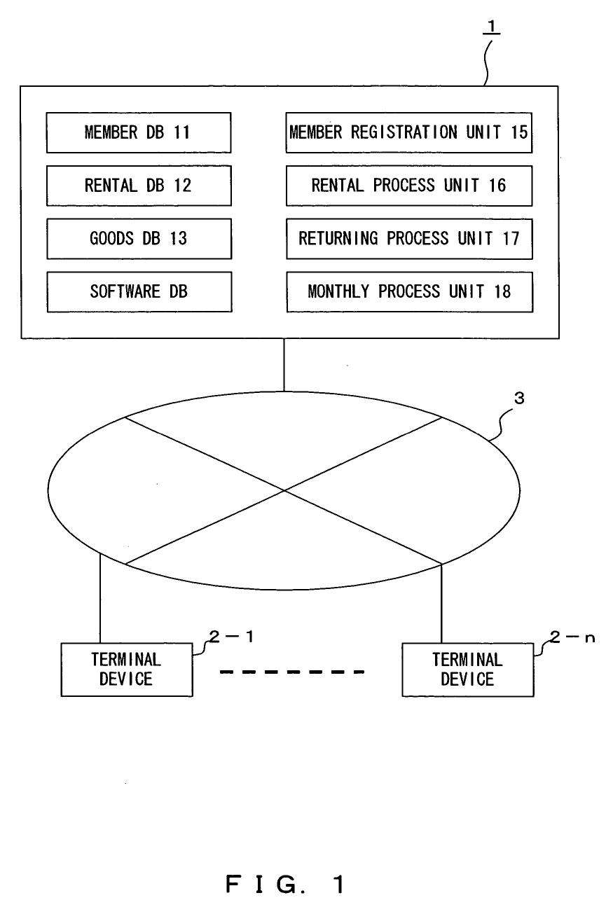

FIG. 1 shows the configuration of the system according to an embodiment of the present invention.

In FIG. 1, the present system receives an order from a client over a network 3, and a distribution center 1 for distributing contents is connected to terminal devices 2-1 through 2-n of a user over the public network 3 such as the Internet.

The distribution center 1 has one or more server devices. It is connected to the terminal device 2 over the network 3, and registers a user, and distributes software to the registered user.

The distribution center 1 comprises a member database 11, a rental database 12, a goods database 13, a software group 14, a member registration unit 15, a rental process unit 16, a returning process unit 17, and a monthly process unit 18.

The member database 11 is a database in which a user is registered, and a member ID for unique identification of each member is stored as associated with member information about the name, the address, etc. of each member. The rental database 12 is a database for management of software rental and stores information about rented software, a rental member, a rental period, etc. The goods database 13 is a database for use by the distribution center 1 managing software to be distributed, sold, or rented as goods to a member. The software group 14 stores plural pieces of software managed as goods in the rental member, and practically stores the body of software, an installation program and an uninstallation program of the software.

The member registration unit 15 is used in registering as a member a user who requests to receive a distribution service of software. The rental process unit 16 performs an installing process when software is rented to a member. The returning process unit 17 performs a process performed when rented software is returned. The monthly process unit 18 is activated at specific intervals and performs a charging process, etc. The details of the processes performed by the member registration unit 15, the rental process unit 16, the returning process unit 17, and the monthly process unit 18 are described later.

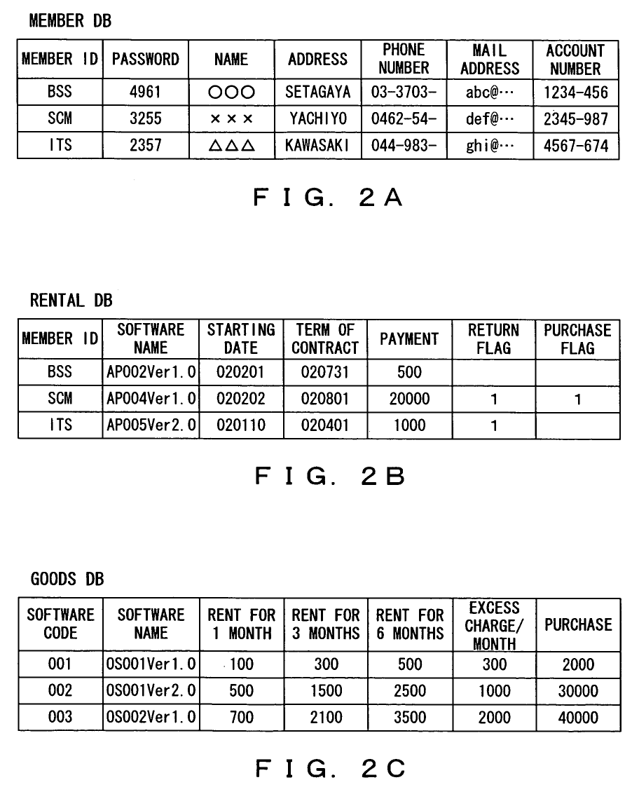

FIG. 2 shows an example of the configuration of the data in each database stored in the distribution center 1.

The member database 11 is a database for management of personal information about a user registered as a member in the distribution center 1, and is used in a user authentication process and a charging process performed when a member logs in the distribution center 1. The member database 11 stores for each member the member ID, the password, the name, the address, the phone number, the mail address, the bank account for use in deduction of a fee, etc. as associated with one another as shown in FIG. 2A.

The rental database 12 is a database for use in recording and managing rented software, and is used in the installing process of installing software on the terminal device 2 of a user, the returning process of deleting software from the terminal device 2, etc. The rental database 12 stores the member ID indicating a person to whom software is rented, the name of rented software, the rental starting date, the contract term indicating the rental period, the rent, a return flag indicating whether or not rented software has been returned, and a purchase flag indicating software has been purchased as associated with one another as shown in FIG. 2B. The record in the rental database 12 is a rental record of each piece of software, and therefore can be used in a tendency analysis, etc.

The goods database 13 is a database stored in the software group 14 for management of the information about software distributable by the distribution center 1, and is used in a rental process, etc. of accepting a request of a member for the rental of software. As shown in FIG. 2C, the goods database 13 stores a software code as an identification code for identification of each piece of software, the name of the software, the rent of the software, that is, the rent for one month, the rent for three months, the rent for six months, an excess charge per month, and the purchase fee as associated with one another.

The operation according to the present embodiment is described below.

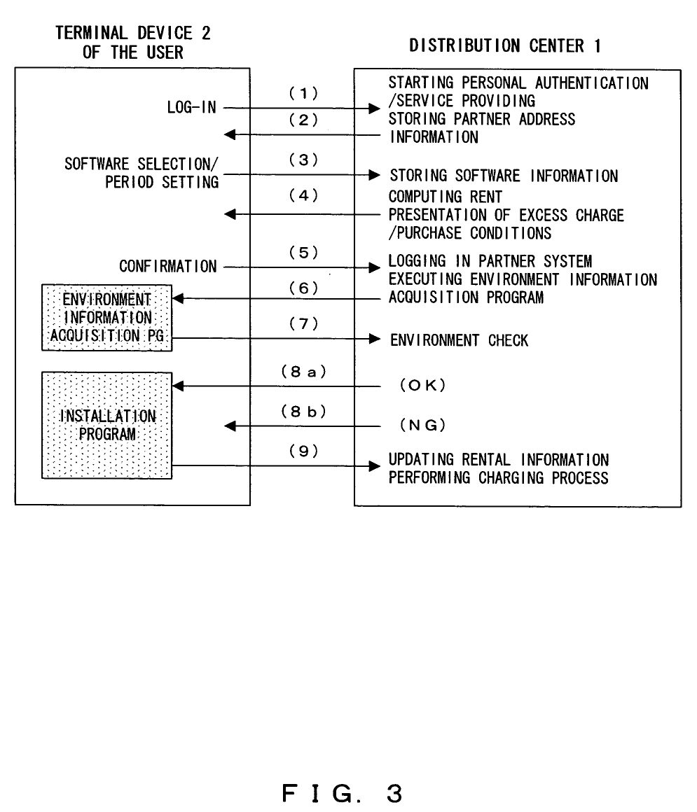

FIG. 3 is a sequential view showing the outline of the data communications performed between the distribution center 1 and the terminal device 2 of a user in a rental process according to the present embodiment. The numbers (1) through (9) in the following explanation corresponds to the numbers shown in FIG. 3.

In FIG. 3, the user first connects the terminal device 2 to the network 3, accesses the distribution center 1 over the network 3, and transmits the member ID and the password, thereby logging into the distribution center 1 ((1)). The distribution center 1 tries to authenticate the user according to the received information, starts the service if the user is authenticated as a member, stores the network address of the terminal device 2 of the user, and notifies the terminal device 2 of the user about the permission of the use of the distribution center 1 ((2)).

The terminal device 2 sequentially selects in the initial procedure on the selection screen displayed on the screen the conditions of rental/purchase of desired software, a rental period, etc., and then notifies the distribution center 1 of the conditions ((3)). The distribution center 1 computes the purchase/rental fee, presents to the use the information about the purchase/rental fee, the excess charge or purchase condition when the rental period is exceeded, etc., and prompts the user to confirm the conditions ((4)).

The user confirms the condition, returns the confirmation to the distribution center 1 ((5)). Upon receipt of this, the distribution center 1 downloads the environment information acquisition program into the terminal device 2 for an environment check of the terminal device 2 of the user ((6)).

The environment information acquisition program checks the information about the configuration of an installed program, file, directory, etc., the information based on the hardware environment such as the available capacity of the auxiliary storage device for installing a program, etc., and notifies the distribution center 1 of the check result ((7)).

According to the above-mentioned information, the distribution center 1 checks the environment of the terminal device 2 of the user. If the software requested as a result of the check can be installed, then an installation program is downloaded and activated, and a downloading process and an installing process of software are performed ((8a)) If the terminal device 2 of the user cannot install software as is, the notice is given as a message to the terminal device 2 of the user ((8b)).

When the software is completely installed, the terminal device 2 notifies the distribution center 1 of the completion of the installing process. Upon receipt of the notice, the distribution center 1 updates the rental information and performs a charging process ((9)).

Thus, requested software for rent is distributed to the terminal device 2 over the network 3, and installed thereon. The distribution center 1 receives the completion notification of the software installing process, and records rental information.

Described below is the returning process of rented software.

A user has to return the rented software within the term of contract for use. In this returning process, the distribution center 1 of the user on which the software is installed is connected to the distribution center 1 over the network 3, the installed software is uninstalled, and the notice of the return of the rented software is given to the distribution center 1. Thus, the distribution center 1 determines the rental period of the software, and performs the process of charging the rent.

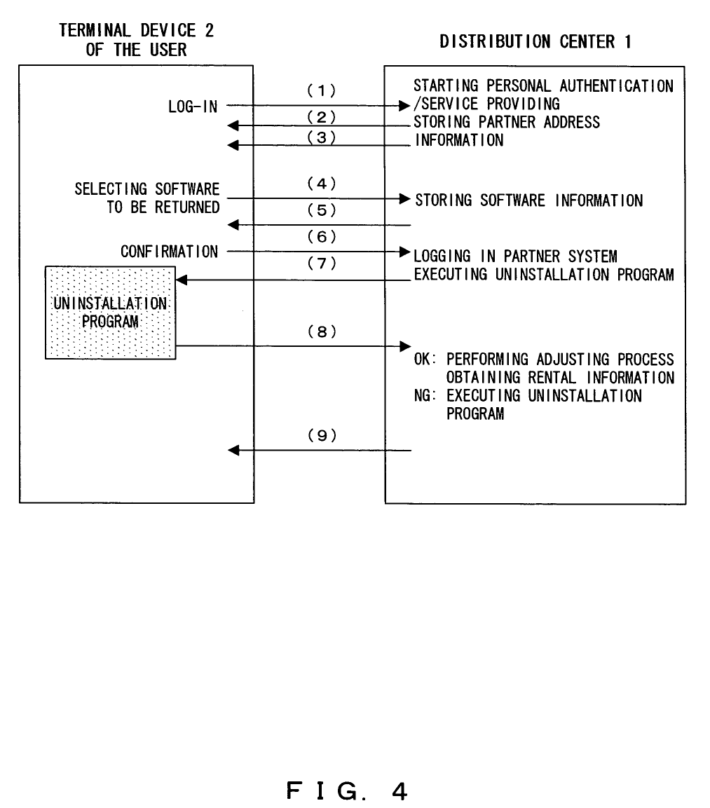

FIG. 4 is a sequential view showing the outline of the data communications between the distribution center and the terminal device of a user in the process of returning rented software according to an embodiment of the present invention. The numbers (1) through (9) in the following explanations correspond to the numbers shown in FIG. 4.

In FIG. 4, the user who returns software first connects the terminal device 2 to the network 3, and accesses the distribution center 1 over the network 3, and notifies it of the member ID and the password, thereby logging in the distribution center 1 ((1)). According to the information, the distribution center 1 tries to authenticate the user. If the user is authenticated as a member, then the distribution center 1 starts providing the service, stores the network address of the terminal device 2 of the user in the network 3, and notifies the terminal device 2 of the user of the use permission of the distribution center 1 ((2)).

Then, the distribution center 1 searches the rental database 12 using a member ID, and displays a list of software rented to the user on the terminal device 2 of the user ((3)).

The user selects the software to be returned from the displayed list, and notifies the distribution center 1 of it ((4)). In response to this, the distribution center 1 gives confirmation notice ((5)). When the confirmation is obtained from the terminal device 2 of the user ((6)), the distribution center 1 downloads the uninstallation program of the software on which the returning process is to be performed on the terminal device 2 of the user, executes the program, and performs the uninstalling process ((7)).

When an unsuccessful uninstallation notice (NG) is received from the uninstallation program in the terminal device 2 of the user, the distribution center 1 installs again the uninstallation program and executes again the uninstallation program as necessary.

When the software is completely uninstalled, and a successful uninstallation notice (OK) is received from the terminal device 2 of the user, the charge adjusting process and the rental information of the rental database 12 is updated, and the process completion message is output to the terminal device 2 of the user ((9)).

Thus, the user can automatically perform the uninstalling process on the software to be returned. The distribution center 1 can adjust the rent by the execution of the returning process by the user.

The details of the process performed by the system according to the present embodiment are sequentially explained below by following the procedure.

In the present system, a member registration is made for a user who requests to take a distribution service of software. Then, a distribution service of software such as sales, rental, etc. of software is offered to the registered member.

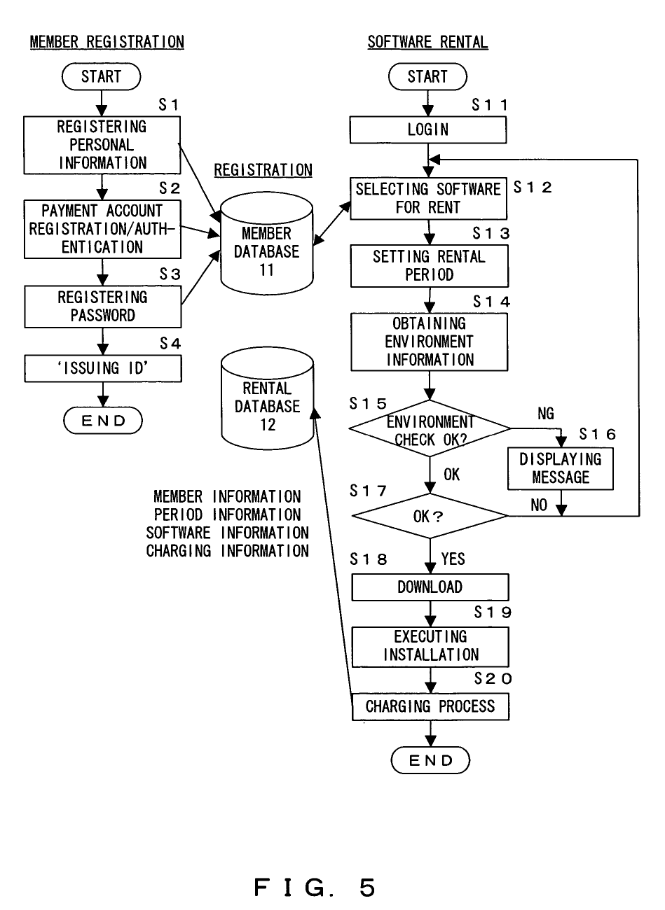

FIG. 5 is a flowchart showing the process performed by the terminal device 2 of a user at the time of member registration, and the process performed by the terminal device 2 of the user in the rental process performed when software is rented to a member.

First, the process performed at the time of member registration is explained below.

A user requesting to take a distribution service of software connects the terminal device 2 to the member registration site of the distribution center 1 over the network 3.

At an instruction from the distribution center 1 displayed on the screen of the terminal device 2 of the user, the user inputs personal information and transmits it to the distribution center 1 in step S1. In step S2, the user inputs the account number of a payment account for the payment of charge and the distribution center 1 authenticates the account. In step S3, the user inputs his or her password and the distribution center 1 registers it. In step S4, a member ID is issued to the user, and displays it to notify the user of the member ID. The personal information, the account number, the password, and the member ID are registered by the member registration unit 15 as the records shown in FIG. 2A in the member database 11 in the distribution center 1.

The member user accesses the distribution service site of the software of the distribution center 1. In response to the distribution request for software from the terminal device 2 of the user, the distribution center 1 activates the accept the rental of, and issues a software select instruction and performs an installing process.

When the terminal device 2 logs into the system (step S11), the accept the rental of is activated, and the distribution center 1 refers to the member database 11 from the member ID and the password transmitted from the terminal device 2 of the user and performs an inquiry process.

As a result, if the member ID and the password match those registered in the member database 11, and thus the user is authenticated as a member, the rental process unit 16 instructs the terminal device 2 of the user to input the selection of rental/purchase, the type of software, etc. When the user inputs these conditions, the notice of the data of software to be rented in response to the input condition is given to the terminal device 2 of the user. The terminal device 2 of the user displays the data on the screen.

The user selects the desired software from the list of the software (step S13), and inputs the rental period (step S14).

When the information is transmitted from the terminal device 2 of the user to the distribution center 1, the rental process unit 16 of the distribution center 1 installs the environment information acquisition program on the terminal device 2 of the user, and activates it.

The environment information acquisition program checks the information about the configuration of an installed program, file, directory, etc., the information based on the hardware environment such as the available capacity of the auxiliary storage device for installing a program, etc., and notifies the distribution center 1 of the check result. According to the information, the rental process unit 16 makes an environment check on the terminal device 2 of the user, and checks whether or not the software selected in step S15 can be installed. As a result of the check, if the terminal device 2 of the user is not in the environment in which the condition of installing the software is not satisfied such as all necessary software is not installed, necessary hardware environment is not completely prepared, etc. (NG in step S15), a message indicating the reason for incapability of installing the software, and then control is returned to step S12.

In step S15, if the terminal device 2 of the user satisfies the environment in which the software can be installed (OK in step S15), a confirmation is made with the user as to whether or not the installing process can be performed in step S17. If the user rejects the installation of the software (NO in step S17), then control is returned to step S12.

If the user permits the installation of the software in step S17 (YES in step S17), the installation program of the software selected in step S12 is downloaded from the distribution center 1 to the terminal device 2 of the user in step S18. In step S19, the installation program is executed and the installing process is performed on the software.

When the installing process is completed, the installation program in the terminal device 2 of the user notifies the distribution center 1 of the completion of the installing process as a charging process (step S20). The distribution center 1 receives the notice, and registers in the distribution service the member information such as a member ID for identification of a member to whom software is rented, the period information indicating the rental period such as the rental starting date, the term of contract for use, etc., the software information for identification of the rented software such as a software name, etc., the charge information such as a payment amount, etc. as rental information, thereby terminating the process.

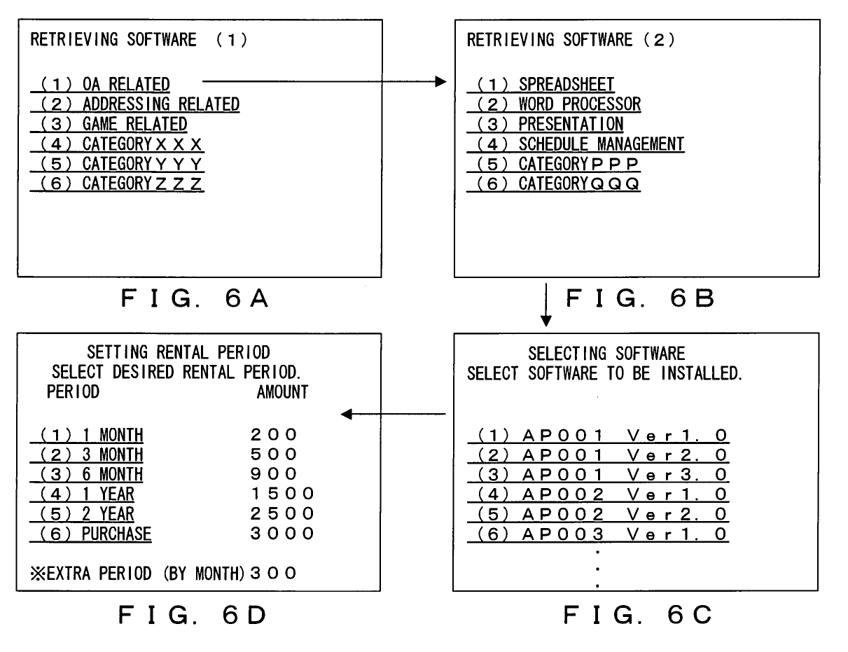

FIG. 6 shows an example of a display screen displayed on the screen of the terminal device 2 of the user when the user selects software.

FIG. 6 shows an example of a display screen displayed when the user selects software to be rented and a display screen on which a rental period is set in the software rental process shown in FIG. 5.

FIGS. 6(a), 6(b), and 6(c) show the selection screens displayed when software is selected, and have the configurations of the selection screens in a hierarchical structure so that desired software can be easily selected from a large number of pieces of software on the selection screen displayed when the software is selected.

When one of the major categories displayed on the screen of the terminal device 2 shown in FIG. 6(a) is selected, a screen displays a smaller category as shown in FIG. 6(b). When one of the items is selected, a screen showing a practical software name is displayed as shown in FIG. 6(c), and the user finally selects the software to be rented on the screen. In FIG. 6, the user selects “(1) OA related” on the display screen in FIG. 6(a), selects “(1) OA display screen” on the display screen in FIG. 6(b), and selects “(1) AP001” on the display screen in FIG. 6(c).

When the user-desired software is selected on the displayed selection screen such as FIG. 6(a), (b), and (c), the distribution center 1 searches the goods database 13, checks the rent of the selected software, and displays the rental period setting screen as shown in FIG. 6(d) on the terminal device 2 of the user. On the rental period setting screen, the allowed rental period, the rent, the charge for extension billed when a term of contract for use is exceeded, and the purchase fee when the software is purchased are displayed for the software selected in FIG. 6(c), and the user selects the desired rental period. The software to be rented and its rental period selected by the user are reported to the distribution center 1 from the terminal device 2 of the user, and recorded as a rental record and managed.

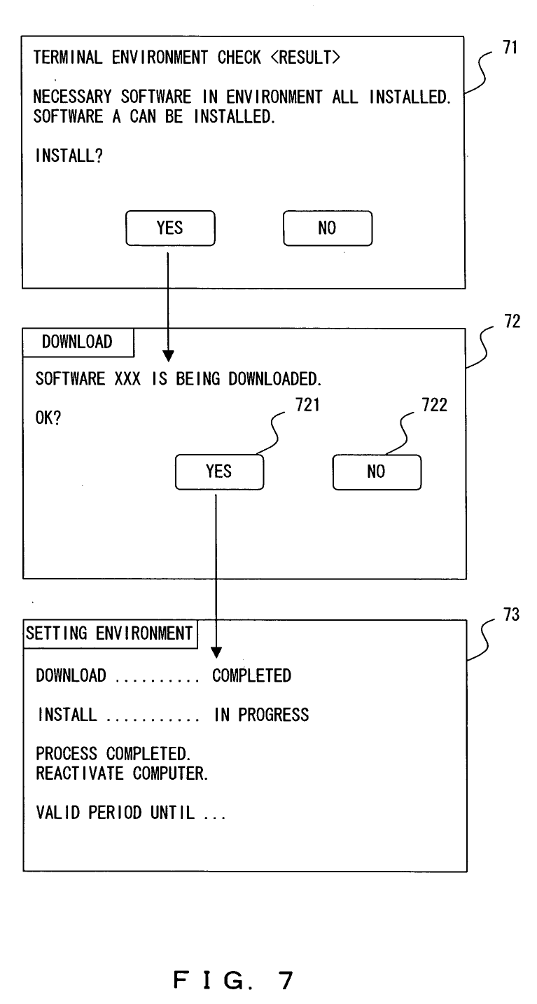

FIG. 7 shows an example of the display screen displayed on the terminal device 2 of the user when it is determined as a result of the environment check in step S15 shown in FIG. 5 that the terminal device 2 of the user satisfies the environment in which the software can be installed.

A display screen 71 shown in FIG. 7 is a confirmation screen for execution of the installing process. On the display screen 71, it is announced that the software specified by the user can be installed on the terminal device 2, and it is checked whether or not the user is performing the installing process. If a “YES” button 711 is selected on the screen, the next display screen 72 is displayed. When a “NO” button 712 is selected, the execution of the installing process is canceled.

The display screen 72 is a confirmation screen of software to be installed. As shown in FIG. 7, the name of the software to be installed is displayed, and it is checked with the user whether or not the software is to be downloaded. If a “YES” button 721 is selected on the screen, the software is downloaded and installed, and the expired contents displays a display screen 73 showing the progress of the process. If a “NO” button 722 is selected on the display screen 72, the installation of the software is canceled.

The display screen 73 displayed when the “YES” button 721 is selected on the display screen 72, and the installation of the software is performed shows the progress of the process of downloading and installing software, the guide to the process performed by the user after the installation, the notice of the rental period, etc. are reported to the user.

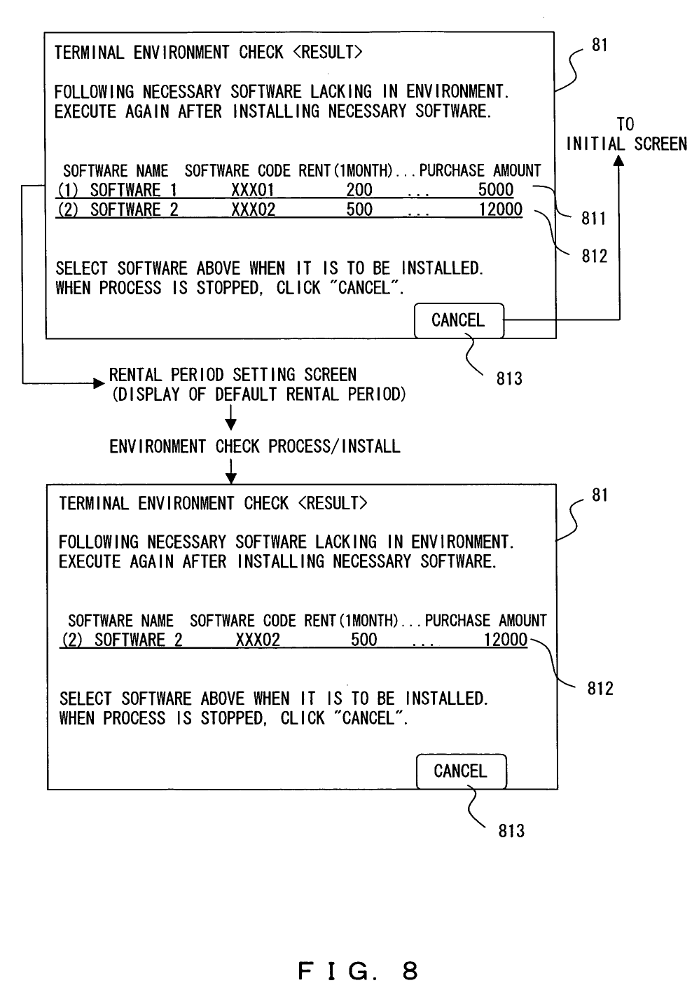

FIG. 8 shows an example of a display screen displayed on the terminal device 2 of the user when it is determined as an environment check in step S15 shown in FIG. 5 that the terminal device 2 of the user does not satisfy the environment of installing software.

A display screen 81 shown in FIG. 8 is an example of a screen for notice of the reason when the terminal device 2 of the user is not in the environment of installing the user-specified software as a result of the environment check. In the case shown in FIG. 8, it is informed that plural pieces of software necessary to install the user-desired software have not been installed in the terminal device 2 of the user. It is also an example of a screen prompting the installation of necessary software, and shows the reason for the incapability of installing the software, and information 811 and 812 (software name, software code, rent, and purchase fee) about the lacking software is displayed.

The information 811 and 812 about the lacking software is linked. When the user selects the information 811 of 812 about the lacking software, the process of installing the corresponding software is started, and the rental period setting screen shown in FIG. 7(d) is displayed on the terminal device 2 of the user. When the user selects the desired rental period on the screen, the environment check and the installing process are performed on the terminal device 2 of the user. When the installing process is completed, and another lacking software is stored, a display such as a display screen 82 is performed on the terminal device 2 of the user, thereby prompting the user to install the lacking software. The display screen 82 shown in FIG. 8 shows an example of a screen displayed on the terminal device 2 of the user after the software 1 is installed. Then, the user is prompted to install the software 2.

When the user selects a “CANCEL” button 813 on the display screen 81 or 82, the process of installing the software is canceled, and the initial screen displayed when the terminal device 2 of the user logs into the distribution center 1 is displayed on the terminal device 2 of the user, and the user selects again the rental/purchase on the screen, inputs the conditions of the types of software, or logs off the distribution center 1, thereby terminating the process.

In the rental process on the software, the user can automatically install the desired software to be rented. When it is automatically checked whether or not the software can be installed and it is determined that the software cannot be installed, an appropriate environment is prepared by installing necessary software, etc. so that the desired software can be installed. The distribution center 1 can manage the rental period by setting the completion notification about the installation of the software from the terminal device 2 of the user as the start of the rental.

Described below is the returning process on the rented software.

The user has to return rented software within the term of contract for use. If the software is not returned, the corresponding period is counted as the rental period of the software, and the rent is charged.

The returning process is performed by connecting the terminal device 2 on which the rented software is installed to the return site of the distribution center 1 over the network 3.

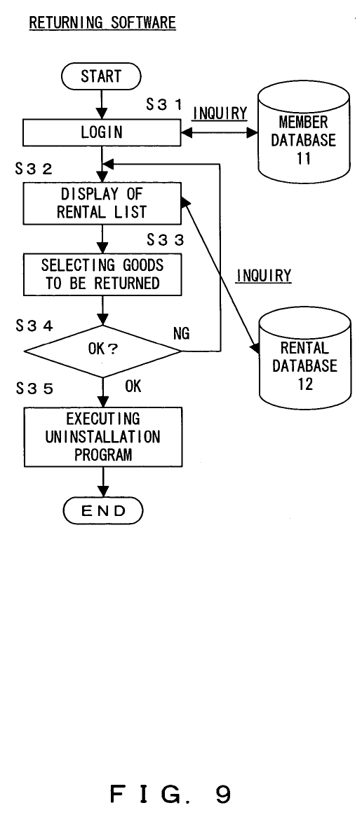

FIG. 9 is a flowchart of the process performed by the terminal device 2 of the user in the returning process.

In FIG. 9, the terminal device 2 of the user is first connected to the network 3, and accesses the software return site of the distribution center 1 over the network 3. In the return site, the log-in process is performed in step S31, and the member number and the password input by the user are sent to the member database 11 for inquiry.

As a result, if the user is authenticated as a member, the data indicating the software being rented is reported based on the result of referring to the distribution service from the distribution center 1. Based on this, the terminal device 2 of the user displays a list of software being rented on the screen in step S32.

On the screen, the user selects and inputs one or more pieces of software to be returned (uninstalled) (step S33), and finally selects and inputs “OK” for the confirmation of the execution of the processes (OK in step S34) . Then, in step S35, an uninstallation program is installed on the terminal device 2 of the user from the distribution center 1 for execution.

Using the uninstallation program, the software to be returned is uninstalled. When the successful uninstallation notice is given to the distribution center 1, the distribution center 1 receives the notice, updates the rental database 12, and determines the rent.

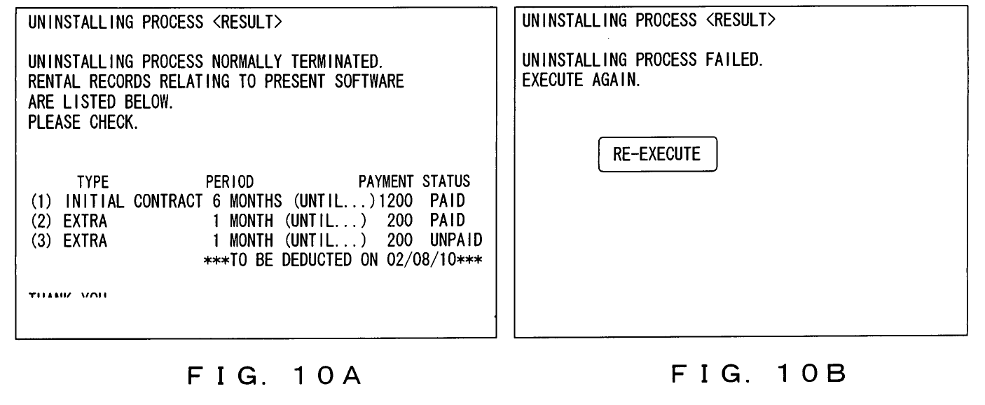

FIG. 10 shows an example of a display screen displayed on the terminal device 2 of the user based on the result of the uninstalling process in step S35 shown in FIG. 9.

FIG. 10(a) shows an example of a display screen displayed when an uninstalling process is normally terminated. When software is successfully uninstalled, the receipt of the rent and the deduction date of the rent are displayed for notice to the user. On the display screen example shown in FIG. 10, the initial charge of the contract set during the installing process at the start of the rental contract for 6 months is ¥1200, the extra rental time per month is ¥200, and only the charge for extension of ¥200 for the last month has not been paid, and is to be deducted from the account on Aug. 10, 2002. On the display screen, the user can recognize the completion of the returning process of the rented software, the charged rent, and the deduction date.

FIG. 10(b) shows an example of a display screen displayed when the uninstalling process has abnormally terminated. The user is given an unsuccessful uninstallation notice, and is prompted to perform again the uninstalling process. On the screen, when the user selects a “RE-EXECUTE” button 101, the uninstalling process is performed again.

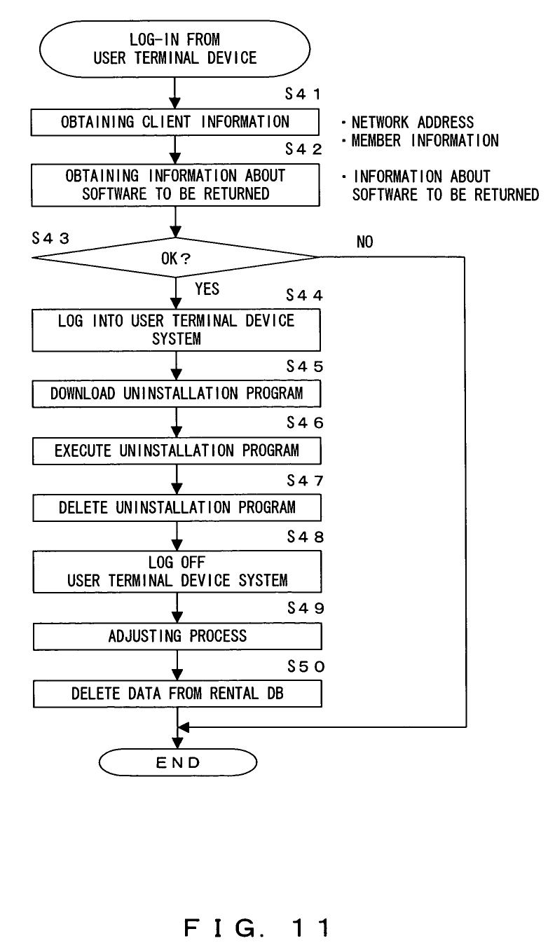

FIG. 11 is a flowchart of the process performed by the distribution center 1 in the returning process.

The process shown in FIG. 11 is performed by the returning process unit 17 when the terminal device 2 of the user logs into the distribution center 1.

When the terminal device 2 of the user of the user logs into the terminal device 2 of the user, the returning process unit 17 first obtains from the terminal device 2 the network address of the terminal device 2 in the network 3, the member information such as the user ID, etc. in step S41. Using the member information, the returning process unit 17 refers to the rental database 12, and the list of the software rented to the member is given to the terminal device 2 of the user.

The returning process unit 17 obtains from the terminal device 2 of the user the software to be returned and selected by the user on the display screen of the terminal device 2 of the user in step S42. When it recognizes the uninstallation of the software selected by the user on the confirmation screen in step S43 (YES in step S43), the distribution center 1 logs into the system of the terminal device 2 of the user in step S44. If the user does not recognize the uninstallation in step S43 (NO in step S43), then the process terminates.

The distribution center 1 which logs into the terminal device 2 of the user in step S44 searches for the uninstallation program of the software selected by the user in the software group 14 by referring to the member database 11, downloads the program into the terminal device 2 of the user in step S45, and executes the downloaded uninstallation program in step S46.

When the uninstallation program uninstalls the software from the terminal device 2 of the user, and when the completion notification receives a completion notification of the uninstallation from the uninstallation program, it deletes the uninstallation program in the terminal device 2 of the user in step S47, and logs off the system of the terminal device 2 of the user step S48.

Then, the returning process unit 17 performs the process of adjusting the charge by confirming the amount to be charged as the rent in step S49 and gives the notice to the terminal device 2 of the user, and updates the data by setting a return flag and/or a purchase flag to 1 for the record corresponding to the rental database 12 in step S50.

In the process of returning the software, the terminal device 2 of the user can automatically uninstall the software to be returned. Furthermore, the distribution center 1 can uninstall the software to be returned without fail, and the process completion notification from the uninstallation program is recognized as the return in the rental, thereby correctly managing the rental period.

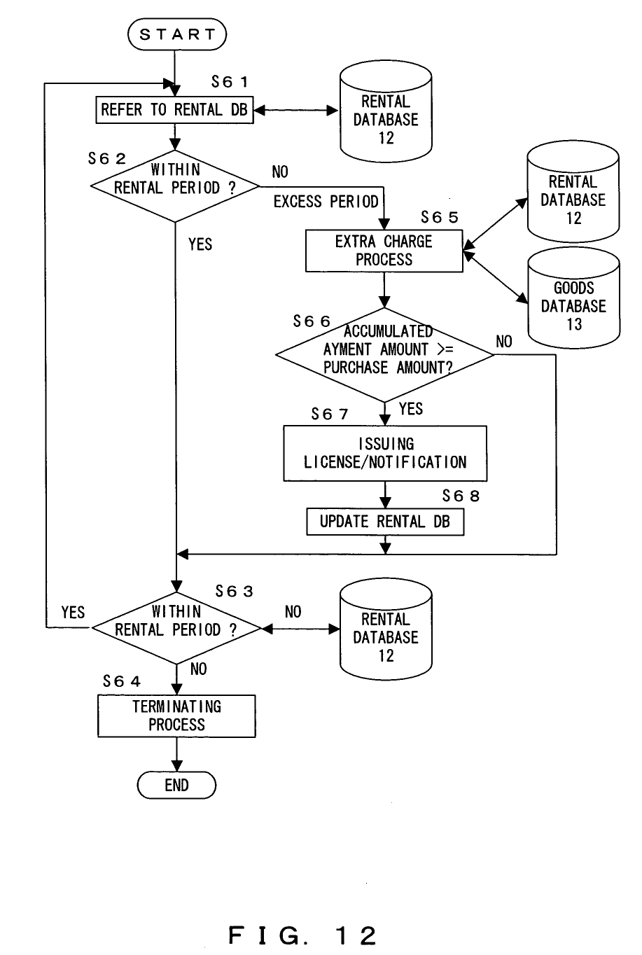

FIG. 12 is a flowchart of the monthly process performed in a specific period by the monthly process unit 18 of the distribution center 1.

In this monthly process, an excess charge process is performed on the rented software exceeding the rental period. Since the rental period is set in a month unit in the present embodiment, the monthly process is performed every month, but the operation timing of performing the monthly process can be optionally selected as the appropriate period and interval by setting a rental period, extra rental time, and configuring a setting unit, etc.

The distribution center 1 activates the monthly process unit 18 in a specific period and a specific day.

The monthly process unit 18 refers to the record in the rental database 12 in step S61.

Then, it is determined whether or not the rental period recorded in the referenced record has been exceeded. If not exceeded (YES in step S62), it is checked whether or not the rental database 12 contains an unreferenced record. If an unreferenced record has a subsequent record (YES in step S63), control is returned to step S61, and the next record in the rental database 12 is referenced.

If the record referenced in step S61 indicates that the rental period is exceeded (NO in step S62), the rental database 12 and the goods database 13 are referred to and the amount of charge and the excess charge is collected, and the newly delayed amount if added to the charge for excess amount (step S65). If the accumulated amount of payment obtained in step S65 exceeds the purchase fee of the software being rented (YES in step S66), then the rented software is changed from the rental to the purchase and a license is issued. Simultaneously, The notice is given to the terminal device 2 of the user, and a purchase flag and a return flag are set for the corresponding record in the rental database 12 in step S68, thereby passing control to step S63. If the accumulated amount of payment has not exceeded the purchase fee in step S66 (NO in step S66), then the fee for the delayed period is newly added to the charge, and control is passed to step S63.

If it is determined in step S63 that all records have been referenced in the rental database 12 (NO in step S63), then the terminating process such as outputting a process completion message to the terminal device 2 of the user is performed, and the process terminates.

In this monthly process, expired contents can be detected and extra charge can be applied.

A product rented in excess of rental period can be set as software to be purchased, and no extra rent is automatically applied.

In the above-mentioned embodiments, software is provided as contents to be distributed to a user, but the contents according to the present invention are not limited to software, but can be moving pictures, still images such as pictures, photographs, etc. music, etc. In this case, a specific regeneration program can be added to the data of each contents. When contents are returned, the regeneration program installed on the terminal device 2 of the user is uninstalled. The contents can also be an access right to the information site of the network 3.

According to the present embodiment, an uninstallation program is downloaded into the terminal device 2 of the user to avoid incorrect uninstallation, but an uninstallation program can be downloaded into the terminal device 2 of the user when software is downloaded so that the uninstallation program can be activated by the distribution center 1 over the network 3.

Furthermore, the contents to be distributed according to the present embodiments are those that can be executed offline after the installation. However, the contents can be executed after access to the distribution center 1 at the activation. In this case, the use rate of the contents is not charged by the period in which the contents are rented as in the above-mentioned embodiments, but can be charged by the use frequency. With this configuration, when the contents are activated and connected to the distribution center 1, the notice of the remaining days up to the end of the term of contract, extra charge, purchase of contents, etc. can be given.

In the present embodiments, the charge of the rent is deducted from the account. However, in the present invention, other methods, for example, E-commerce, etc. can be realized.

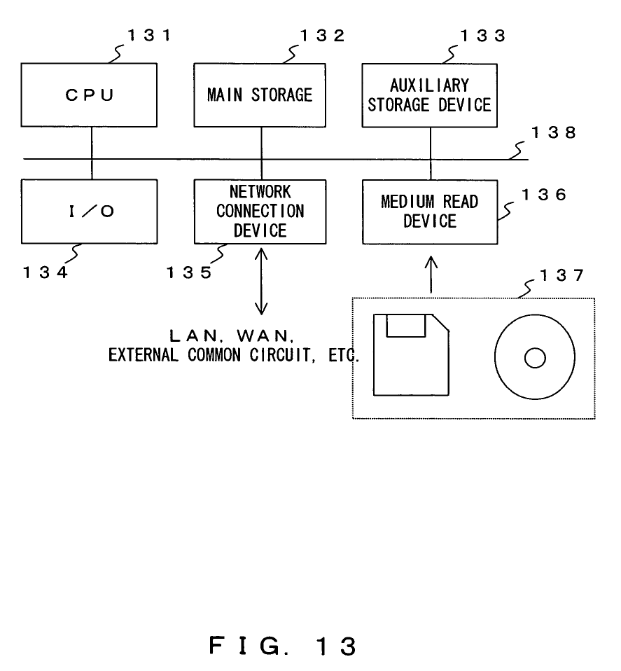

FIG. 13 is an environment chart of the information processing system of the server device and the terminal device 2 of the user configuring the distribution center 1.

The information processing system comprises a CPU 131, a main storage 132 which can be a work area of each program, an auxiliary storage device 133 such as a hard disk, etc. on which each program and database are recorded, an input/output device (I/O) 134 such as a display, a keyboard, etc., a network connection device 135 such as a modem, etc., and a medium read device 136 for reading stored contents from a portable record media such as a disk, magnetic tape, etc. These components are connected via bus 138.

In the information processing system shown in FIG. 13, the medium read device 136 reads a program and data stored in a record medium 137 such as a magnetic tape, a flexible disk, CD-ROM, a MO, etc. so that they can be downloaded into the main storage 132 or the auxiliary storage device 133. Each process according to the present embodiments can be realized as software by the CPU 131 executing the program and data.

In the information processing system shown in FIG. 13, application software can be exchanged using a record medium 1147 such as a floppy disk, etc. Therefore, the present invention is not limited to a rental program management system or a rental management method, but can be configured as a computer-readable record medium 137 to direct a computer to perform the functions of the above-mentioned embodiments of the present invention when they are used in a computer.

In this case, “record medium” includes a removable record medium 146 from a medium drive device 147 of CD-ROM, a floppy disk (or a MO, DVD, removable hard disk, etc.), a storage unit (database, etc.) 142 in an external device (server, etc.) transmitted through a network circuit 143, or memory (RAM or hard disk, etc.) 145 in a body 144 of an information processing device 141, etc. A program stored in the record medium 146 and the storage unit (database, etc.) 142 is loaded into the memory (RAM or hard disk, etc.) 145 in the body 144 and is then executed.

Industrial Applicability

According to the present invention, contents for rent can be provided for a user over a network. Therefore, the contents can be provided less inexpensively than when contents are purchased or provided through other sales routes.

Furthermore, contents providers can be notified of the completion of the uninstalling process when contents are returned. Therefore, the correct deletion of the rented software can be recognized.

A contents provider can also manage the rental period by the notice the installation and return of the contents.

A user who can be provided with contents can easily obtain contents over a network.

The contents can be provided at a lower rent or charge.

A user who can be provided with contents can automatically perform installing/uninstalling processes on contents. Therefore, even a beginner user can easily obtain the contents.

A user who can be provided with contents is not charged in excess of a predetermined value of a rent although the contents are rented to the user for a prolonged period. Therefore, uses can safely use the service.

1. A server device in a contents rental system used with an information processing system for distributing contents over a communications network to a terminal device of a user, comprising:
an installing unit installing requested contents for rent on the terminal device in response to a rental request from the terminal device;
an uninstalling unit uninstalling the contents from the terminal device in response to a request from the terminal device to return the contents for rent from the terminal device; and
a rental information management unit determining a rental period in which the contents are rented according to an installation completion notification and an uninstallation completion notification from the terminal device.

2. The server device according to claim 1, further comprising a charging unit determining a rent based on the rental period, and setting a special value as the rent when the rent determined based on the rental period exceeds the special value.

3. The server device according to claim 2, wherein said installing unit checks whether or not, in response to a rental request from the terminal device, the requested contents for rent are in an environment in which the contents can be installed on the terminal device, and when the contents can be installed in the environment, the installing process is performed.

4. The server device according to claim 3, wherein said installing unit checks whether or not, in response to a rental request from the terminal device, the requested contents for rent are in an environment in which the contents can be installed on the terminal device, and when the contents can not be installed in the environment, said installing unit prompts a user of the terminal device to install a necessary program.

5. A server device in a contents rental system used with an information processing system for distributing contents over a communications network to a terminal device of a user, comprising:
an installing unit installing requested contents for rent on the terminal device in response to a rental request from the terminal device; and
a rental information management unit managing a period in which the contents installed by said installing unit are rented.

6. The server device according to claim 5, further comprising
an uninstalling unit uninstalling the contents from the terminal device in response to a request from the terminal device to return the contents for rent from the terminal device, wherein
when said uninstalling unit performs an uninstalling process, said rental information management unit determines a rental period in which the contents are rented.

7. A server device in a contents rental system used with an information processing system for distributing contents over a communications network to a terminal device of a user, comprising:
an uninstalling unit uninstalling the contents from the terminal device in response to a request from the terminal device to return the contents for rent from the terminal device; and
a rental information management unit determining a rental period in which the contents are rented when said uninstalling unit performs an uninstalling process.

8. A terminal device to which a distribution center distributes contents over a communications network, comprising:
a unit notifying the distribution center of a distribution request of the contents; and
a unit transmitting a completion notification to the distribution center when the contents specified in the distribution request are completely installed.

9. A terminal device to which a distribution center distributes contents over a communications network, comprising:
a unit for connection to the distribution center over the communications network; and
unit notifying the distribution center of completion of uninstallation of installed contents.

10. A server device in a contents rental system used with an information processing system for distributing contents over a communications network to a terminal device of a user, comprising:
installing means for installing requested contents for rent on the terminal device in response to a rental request from the terminal device;
uninstalling means for uninstalling the contents from the terminal device in response to a request from the terminal device to return the contents for rent from the terminal device; and
rental information management means for determining a rental period in which the contents are rented according to an installation completion notification and an uninstallation completion notification from the terminal device.

11. A server device in a contents rental system used with an information processing system for distributing contents over a communications network to a terminal device of a user, comprising:
installing means for installing requested contents for rent on the terminal device in response to a rental request from the terminal device; and
rental information management means for managing a period in which the contents installed by said installing means are rented.

12. A server device in a contents rental system used with an information processing system for distributing contents over a communications network to a terminal device of a user, comprising:
uninstalling means for uninstalling the contents from the terminal device in response to a request from the terminal device to return the contents for rent from the terminal device; and
rental information management means for determining a rental period in which the contents are rented when said uninstalling means performs an uninstalling process.

13. A terminal device to which a distribution center distributes contents over a communications network, comprising:
means for notifying the distribution center of a distribution request of the contents; and
means for transmitting a completion notification to the distribution center when the contents specified in the distribution request are completely installed.

14. A terminal device to which a distribution center distributes contents over a communications network, comprising:
means for connection to the distribution center over the communications network; and
means for notifying the distribution center of completion of uninstallation of installed contents.

15. A rental management method for software in an information processing system for distributing contents over a communications network to a terminal device of a user, comprising:
installing requested contents for rent on the terminal device in response to a rental request from the terminal device;
uninstalling the contents from the terminal device in response to a request from the terminal device to return the contents for rent from the terminal device; and
determining a rental period in which the contents are rented according to an installation completion notification and an uninstallation completion notification from the terminal device.

16. The rental management method according to claim 15, further comprising determining a rent based on the rental period, and setting a special value as the rent when the rent determined based on the rental period exceeds the special value.

17. The rental management method according to claim 16, wherein it is checked whether or not, upon receipt of a rental request from the terminal device, the requested contents for rent are in an environment in which the contents can be installed on the terminal device in the environment, and when the contents can be installed, the installing process is performed.

18. The rental management method according to claim 17, wherein it is checked whether or not, upon receipt of a rental request from the terminal device, the requested contents for rent are in an environment in which the contents can be installed on the terminal device, and when the contents can not be installed in the environment, a user of the terminal device is prompted to install a necessary program.

19. A rental management method for use with an information processing system for distributing contents over a communications network to a terminal device of a user, comprising:
installing requested contents for rent on the terminal device in response to a rental request from the terminal device; and
storing and managing a period in which the installed contents are rented.

20. The rental management method according to claim 19, wherein the contents are uninstalled from the terminal device in response to a request from the terminal device to return the contents for rent from the terminal device, and when the contents are uninstalled, a rental period in which the contents are rented is determined.

21. A software rental management method for use with an information processing system for distributing contents over a communications network to a terminal device of a user, comprising:
uninstalling the contents from the terminal device in response to a request from the terminal device to return the contents for rent from the terminal device; and
determining a rental period in which the contents are rented when the contents are uninstalled.

22. A software rental management method for use with a terminal device to which a distribution center distributes contents over a communications network, comprising:
notifying the distribution center of a distribution request of the contents; and
transmitting a completion notification to the distribution center when the contents specified in the distribution request are completely installed.

23. A software rental management method for use with a terminal device to which a distribution center distributes contents over a communications network, comprising:
making a connection to the distribution center over the communications network; and
notifying the distribution center of completion of uninstallation of installed contents.

24. A co-server-readable storage medium storing a program used in a server device in an information processing system for distributing software over a communications network to a terminal device of a user to direct the server device to perform the steps, comprising:
installing requested contents for rent on the terminal device in response to a rental request from the terminal device;
uninstalling the contents from the terminal device in response to a request from the terminal device to return the contents for rent from the terminal device; and
determining a rental period in which the contents are rented according to an installation completion notification and an uninstallation completion notification from the terminal device.

25. A co-server-readable storage medium storing a program used in a server device in an information processing system for distributing software over a communications network to a terminal device of a user to direct the server device to perform the steps, comprising:
installing requested contents for rent on the terminal device in response to a rental request from the terminal device; and
storing and managing a period in which the installed contents are rented.

26. A co-server-readable storage medium storing a program used in a server device in an information processing system for distributing software over a communications network to a terminal device of a user to direct the server device to perform the steps, comprising:
uninstalling the contents from the terminal device in response to a request from the terminal device to return the contents for rent from the terminal device; and
determining a rental period in which the contents are rented when the contents are uninstalled.

27. A computer data signal embodied in a carrier wave and representing control software, said control software comprising the processes of:
installing requested contents for rent on the terminal device in response to a rental request from the terminal device;
uninstalling the contents from the terminal device in response to a request from the terminal device to return the contents for rent from the terminal device; and
determining a rental period in which the contents are rented according to an installation completion notification and an uninstallation completion notification from the terminal device.

28. A computer data signal embodied in a carrier wave and representing control software, said control software comprising the processes of:
installing requested contents for rent on the terminal device in response to a rental request from the terminal device; and
storing and managing a period in which the installed contents are rented.

29. A computer data signal embodied in a carrier wave and representing control software, said control software comprising the processes of:
uninstalling the contents from the terminal device in response to a request from the terminal device to return the contents for rent from the terminal device; and
determining a rental period in which the contents are rented when the contents are uninstalled.

30. The server device according to claim 1, wherein said installing unit checks whether, in response to a rental request from the terminal device, the requested contents for rent are in an environment in which the contents can be installed on the terminal device, and when the contents can be installed in the environment, the installing process is performed.

31. The rental management method according to claim 15,
further comprising checking, upon receipt of a rental request from the terminal device, whether the requested contents for rent are in an environment in which the contents can be installed on the terminal device, and
wherein said installing is performed if said checking determines that the contents can be installed.

32. The server device according to claim 1, wherein said installing unit checks whether, in response to a rental request from the terminal device, the requested contents for rent are in an environment in which the contents can be installed on the terminal device, and when the contents can not be installed in the environment, said installing unit prompts a user of the terminal device to install a necessary program.

33. The server device according to claim 2, wherein said installing unit checks whether, in response to a rental request from the terminal device, the requested contents for rent are in an environment in which the contents can be installed on the terminal device, and when the contents can not be installed in the environment, said installing unit prompts a user of the terminal device to install a necessary program.

34. The rental management method according to claim 15, further comprising:
checking, upon receipt of a rental request from the terminal device, whether the requested contents for rent are in an environment in which the contents can be installed on the terminal device, and
prompting a user of the terminal device if said checking determines that the contents cannot be installed.

35. The rental management method according to claim 16, further comprising:
checking, upon receipt of a rental request from the terminal device, whether the requested contents for rent are in an environment in which the contents can be installed on the terminal device, and
prompting a user of the terminal device if said checking determines that the contents cannot be installed.
